(19) United States
(12) Patent Application Publication
(10) Pub. No.: US 2002/0141600 A1
(43) Pub. Date: Oct. 3, 2002

(54) System for controlling information received in a moving vehicle

(75) Inventor: Michael J. Siwinski, Rochester, NY (US)

Correspondence Address: Thomas H. Close, Patent Legal Staff, Eastman Kodak Company, 343 State Street, Rochester, NY, 14650-2201, US

(73) Assignee: Eastman Kodak Company

(21) Appl. No.: 09/821,564

(22) Filed: Mar. 29, 2001

(51) Int. Cl. H04B 1/00

(52) U.S. Cl. 381/86

(57) ABSTRACT

A system for controlling information received in a moving vehicle comprises a sensor for sensing if the vehicle is in motion; a processor electrically connected to the sensor for receiving motion data from the sensor, and for directing operations of the vehicle; an electronic component within the vehicle which delivers information to a user of the electronic component, wherein the information being either delivered or received is either disabled or modified by the processor according to the motion data received from the sensor.

### FIELD OF THE INVENTION

This invention relates generally to portable and automotive consumer electronic devices and, more particularly, to such electronic devices in which the safety of the occupants using these devices in an automobile is enhanced by limiting information therefrom or thereto during predefined conditions.

### BACKGROUND OF THE INVENTION

There is a growing trend to add Internet and wireless connectivity to all sorts of portable consumer electronic devices. Typical examples of such devices are cell phones and pagers, hand-held computers, global positioning devices, car stereos, car dashboard displays including “heads-up” displays, laptop computers, and the like. This connectivity will allow a user to read text, view still and moving images, listen to audio content, and interact with the content through touch screens, voice commands, and the like. Automated control of such electronic devices is developing in response to the rapid growth of these devices.

For example, modern vehicles already provide a number of sensed conditions as electrical signals, which are readily accessible to the electronics installed in that vehicle. An example of this is disclosed in U.S. Pat. No. 5,677,960. This patent discloses a car stereo that can sense engine speed (and therefore vehicle speed) by analyzing the AC noise signal component that is present in the DC current supplied to the stereo. The radio adjusts its volume to compensate for various levels of anticipated road noise. Other useful signals present in most vehicles are the speed of the vehicle, which gear the vehicle is in, loss of traction, loss of braking ability, the state of the engine (whether running or off, and the speed of the engine), and the like.

Although the presently known and utilized system of automated control of electronic devices is satisfactory, they include drawbacks. The use of these devices by the driver of a moving vehicle can be inherently dangerous because the driver's attention may be diverted from the road while looking at the content displayed.

Consequently, a need exists for an improved system of receiving electronic information during certain conditions.

### SUMMARY OF THE INVENTION

The present invention is directed to overcoming one or more of the problems set forth above. Briefly summarized, according to one aspect of the present invention, the invention resides in a system for controlling information received in a moving vehicle comprising: (a) a sensor for sensing if the vehicle is in motion; (b) a processor electrically connected to the sensor for receiving motion data from the sensor, and for directing operations of the vehicle; (c) an electronic component within the vehicle which delivers information to a user of the electronic component, wherein the information being either delivered or received is either disabled or modified by the processor according to the motion data received from the sensor.

These and other aspects, objects, features and advantages of the present invention will be more clearly understood and appreciated from a review of the following detailed description of the preferred embodiments and appended claims, and by reference to the accompanying drawings.

### ADVANTAGEOUS EFFECT OF THE INVENTION

The present invention has the advantages of providing safety features that may be desirable or required in order to operate a moving vehicle. These features reduce or eliminate distractions caused by excessive audio and visual information delivered by an electronic device that requires interactive use.

### BRIEF DESCRIPTION OF THE DRAWINGS

The objects, features and advantages of the present invention will be apparent from the following description taken in conjunction with the accompanying drawings, in which:

FIG. 1 is a schematic diagram of the automated control system of the present invention;

FIG. 2 is a preferred embodiment of the electronic device of FIG. 1; and

FIG. 3 is an alternative state of the embodiment of FIG. 2.

### DETAILED DESCRIPTION OF THE INVENTION

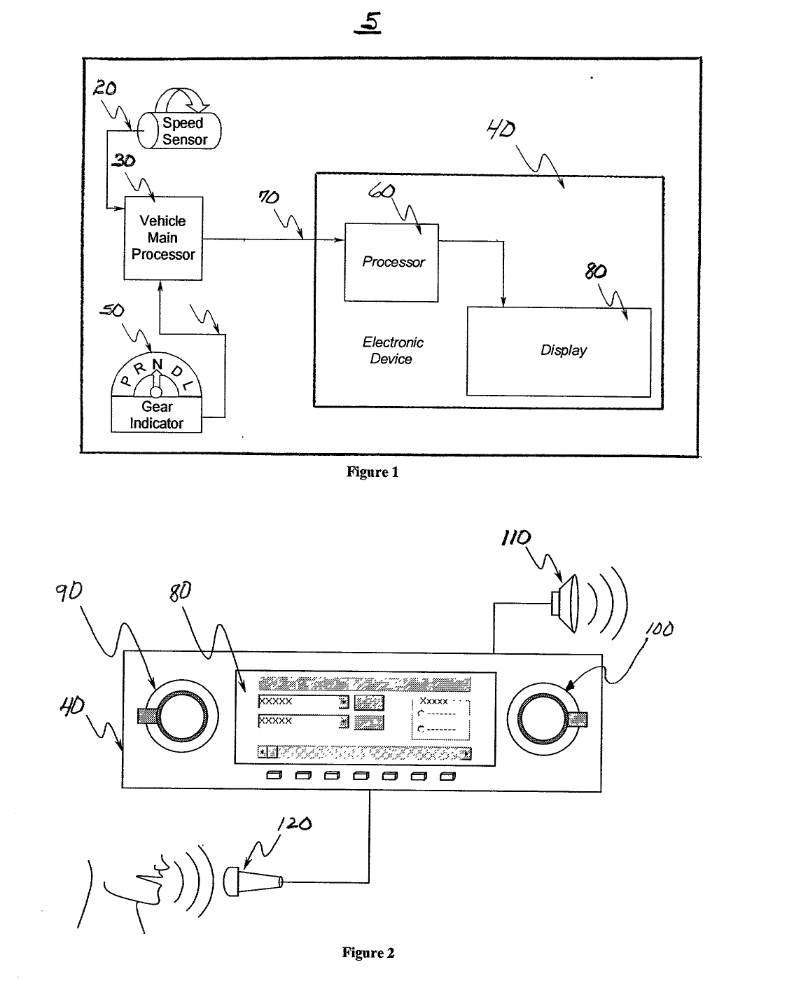

Referring to FIG. 1, there is shown a schematic diagram of the automated control system of the present invention for use in a vehicle 5, for example an automobile. The control system includes a sensor 20 for sensing the speed of the automobile by any well-known means, for example by sensing wheel rotation speed and the like. The sensor 20 is electrically connected to the main processor 30 of the automobile for enabling the processor 30 to automatically direct control of electronics devices 40, as will be described in detail hereinbelow. The main processor 30 is also electrically connected to a gear indicator 50 for permitting the processor 30 to know the gear status, for example park, drive, neutral and the like.

There is also shown any portable electronic device 40, or any electronic device 40 permanently installed in the automobile, having a processor 60 which is electrically connected to the main processor 30. The connection 70 between the two processors 30 and 60 may be either wireless or hardwired. The electronic device 40 further includes a display 80 for displaying information to the occupants of the automobile. This display 80 may be a touch-sensitive display or conventional display. The device 40, either portable or permanently installed, may be wirelessly connected to the Internet for permitting reception and transmission of data thereon.

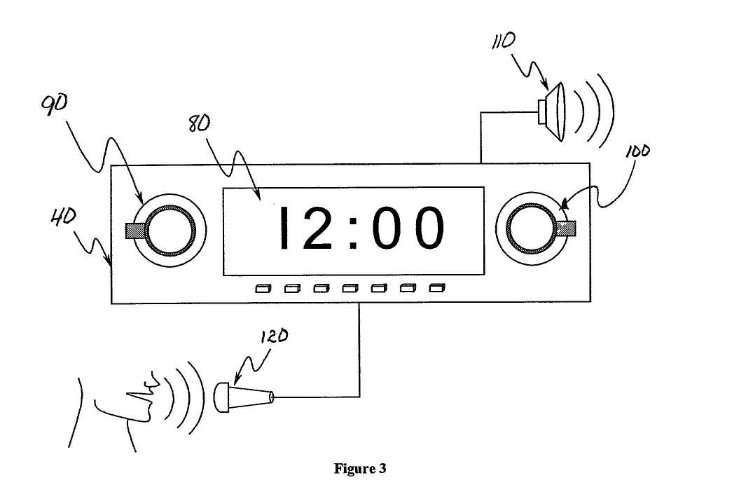

Referring to FIG. 2, there is shown a specific embodiment of the electronic device 40, a car stereo, having a wireless Internet connection, volume 90 and channel 100 control knobs for controlling the sound volume and channel selection, and the display 80 discussed hereinabove.

Referring to both FIGS. 1 and 2, when the sensor 20 does not sense motion, it sends a signal to the main processor 30 for indicating that the vehicle is not in motion. The main processor 30 then sends a signal to the processor 60 of the device also indicating that the vehicle is not in motion. This processor 60 will then enable or permit operation of the Internet connection. Alternatively, or in addition to the above-described enablement of the Internet connection, the gear indicator 50 may be used for enabling the Internet connection. This operation is similar to the above-described process except that the main processor 30 receives a signal from the gear indicator 50 indicating that the vehicle is not currently positioned or engaged in a motion gear. As should be inherent from the above description, the Internet connection is only enabled when the automobile is not in motion and/or the gear indicator 50 is not positioned in a motion gear such as drive, reverse or the like. Conversely, when the automobile is in motion and/or the gear indicator 50 is positioned in a motion gear, the Internet connection is disabled.

Alternatively to having the processor 60 of the car stereo 40 receiving a motion status signal from the vehicle's main processor 30, the car stereo 40 may include a global positioning system, i.e., GPS, (not shown) for detecting motion of the vehicle. In this regard, other electronic devices 40 such as portable devices may also include a GPS for detecting motion.

An additional feature of the current embodiment is that the inputs to the car stereo 40, such as the touch screen input 80 or input from mechanical devices, may be controlled using the sensed motion data in the same manner as for the control of the visual information described hereinabove. The touch sensitive device 80 may be disabled, or the information received from the touch-sensitive device 80 may be substituted, reduced, or modified according to the motion data received from the sensor 20.

Referring to FIG. 2, a still additional feature of the current embodiment is that the audio output 1 10, such as speaker output, or voice input 120, such input as a microphone, of the car stereo 40 may be controlled (disabled, substituted, reduced or modified) using the sensed motion data. In this regard, the process is the same as for visual information except that the audio information is either disabled or enabled according to the motion status signal received from the main processor.

Referring to FIGS. 2 and 3, there is shown the same car stereo 40 when the car is moving or in motion. The sensor 20 senses or detects motion and sends a signal to the main processor 30 indicating that the vehicle is in motion. The main processor 30 then sends a signal to the processor 60 of the device indicating that the vehicle is in motion. This processor 60 will then disable or prohibit operation of the Internet connection. The display 80 of the car stereo may substitute a limited amount of information, such as the time and the like shown in FIG. 3, for the Internet-related information.

The invention has been described with reference to a preferred embodiment. However, it will be appreciated that variations and modifications can be effected by a person of ordinary skill in the art without departing from the scope of the invention. For example, the electronic devices may include such devices as portable computers, global positioning systems, cell phones, pagers and the like. Still further, the present invention may be used in a boat, airplane, motorcycle and the like.

### PARTS LIST

5 automated control system

20 sensor

30 main processor

40 electronic device

50 gear indicator

60 processor

70 connection

80 display

90 volume control knob

100 channel control knob

110 audio output

120 voice input

What is claimed is:

1. A system for controlling information received in or transmitted from a moving vehicle comprising:
(a) a sensor for sensing if the vehicle is in motion;
(b) a processor electrically connected to the sensor for receiving motion data from the sensor, and for directing operations of the vehicle; and
(c) an electronic component within the vehicle which delivers information to a user of the electronic component, wherein the information being either delivered or received is either disabled or modified by the processor according to the motion data received from the sensor.

2. The system as in claim 1 further comprising a display electrically connected to the electronic component which said display is disabled according to the motion data received from the sensor.

3. The system as in claim 1 further comprising a display electrically connected to the electronic component which information being displayed by the display is either substituted, reduced, or modified according to the motion data received from the sensor.

4. The system as in claim 1 further comprising an audio output component having audio output which audio output being delivered by the audio output component is either disabled, substituted, reduced, or modified according to the motion data received from the sensor.

5. The system as in claim 1 further comprising a touch-sensitive input device having user input received by the touch-sensitive input device wherein the touch-sensitive device is disabled, or information received from the touch-sensitive device is either substituted, reduced, or modified according to the motion data received from the sensor.

6. The system as in claim 1 further comprising a voice input device having user input received by the voice input device wherein the voice-input device is disabled, or information received from the voice-input device is either substituted, reduced, or modified according to the motion data received from the sensor.

7. The system as in claim 1 further comprising a mechanically activated input device having user input received by the mechanical device, wherein the mechanical device is disabled, or input received from the mechanical device is either substituted, reduced, or modified according to the motion data received from the sensor.

8. The system as in claim 1 further comprising a connection to a data network having data received from or supplied to the data network, wherein the connection to the data network is disabled, or the received or supplied data is either substituted, reduced, or modified according to the motion data received from the sensor.

9. The system as in claim 1 wherein the electrical component is either portable or integrally attached to the vehicle.
